(19) United States
(12) Patent Application Publication
(10) Pub. No.: US 2011/0137438 A1
(43) Pub. Date: Jun. 9, 2011

(54) Video conference system and method based on video surveillance system

(75) Inventor: Zhiyu Zhang, Beijing (CN)

(73) Assignees: Vimicro Electronics Corporation, Tianjin (CN); Vimicro Corporation, Beijing (CN)

(21) Appl. No.: 12/632,782

(22) Filed: Dec. 7, 2009

(51) Int. Cl. G06F 15/16; G06F 15/173; G06F 17/00

(52) U.S. Cl. 700/94; 709/231; 709/224

(57) ABSTRACT

A video conference system based on a surveillance system is disclosed. According to one aspect of the system, there is a surveillance system including a monitoring server and a streaming media server. A gateway is provided to for protocol conversion between a meeting terminal and the monitoring server as well as between a meeting terminal and the streaming media server to facilitate seamless transmission of signal and media streams among all meeting participants (e.g., terminal devices). In addition an audio mixing point and a video forwarding point are created for a meeting to facilitate the data exchange among all meeting participants.

### BACKGROUND OF THE INVENTION

1. Field of the Invention

The present invention is related to the area for video surveillance, more particularly related to video conference system and method based on a video surveillance system.

2. Description of Related Art

There are a variety of communication systems depending on multimedia techniques in the prior art, e.g. a video monitoring system and a meeting system etc. However, these systems are designed and constructed independently and separately. In other words, the video monitoring system is a system independent from the meeting system.

FIG. 1 duplicates FIG. 3 of U.S. Pat. No. 6,462,773 about a video surveillance system. Besides a camera 1 and a display unit 4, the system 100 includes a processing unit 3 that further includes a first interface (I/F) 6 and a second I/F 9. A digital video signal input from the camera 1 via the first I/F 6 is written to a video memory 7. The second I/F 9 is connected to the display unit 4. A controller 10 detects a movement on the basis of the mean values of luminance data of the current frame and those of a frame appeared several frames before the current frame, and outputs movement detection data.

FIG. 2 is a block diagram schematically showing a conventional video conference or meeting system 200 that includes a meeting control unit (MCU) 202 and a plurality of meeting terminals 204. The MCU 202 is responsible for control of ongoing meetings among the meeting terminals 204, audio mixing and distribution of meeting audio streams, and distribution of meeting video streams. The meeting terminals 204 may be session initiation protocol (SIP) terminals, H.323 protocol terminals or H.248 protocol terminals.

However, both video surveillance systems and video conference systems are independently developed. Having both systems in place would be costly. Thus, there is a need for an integrated system that may be used for both surveillance and video conference.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to an integrated system that may be used for both surveillance and conference or a video conference system based on a surveillance system. According to one aspect of the present invention, there is a surveillance system including a monitoring server and a streaming media server. A gateway is provided to for protocol conversion between a meeting terminal and the monitoring server as well as between a meeting terminal and the streaming media server to facilitate seamless transmission of signal and media streams among all meeting participants (e.g., terminal devices).

According to another aspect of the present invention, in accordance with a meeting start instruction from a monitoring server, the streaming media server assigns an audio mixing point to the meeting, causes meeting participants to join the audio mixing point, where the monitoring server is configured to mix audio streams from the meeting participants, and distributes the mixed audio streams to other meeting participants. Meanwhile the streaming media server is configured to cause meeting participants to join the audio mixing point via the access gateway, and distribute the mixed audio streams to the other meeting participants via the access gateway.

According to yet another aspect of the present invention, the monitoring server is configured to instruct the streaming media server to create a video forwarding point, informs the streaming media server of the media capability of the moderator client, and instructs the streaming media server to cause the moderator client to join the video forwarding point. While the streaming media server creates the video forwarding point, it responds a message indicating that the video forwarding point is created successfully for the monitoring server, and returns the media capability of the video forwarding point to the monitoring server. The media capability of the video forwarding point comprises a media format available for the video forwarding point and a receiving address of the video forwarding point. As a result, a video conference is conducted over a surveillance system

There are a lot of objects, features, and advantages in the present invention including an integrated system for both surveillance and video conference.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a block diagram schematically showing a conventional video monitoring system;

FIG. 2 is block diagram schematically showing a conventional meeting system;

FIG. 3 is a block diagram schematically showing a video monitoring meeting system according to one embodiment of the present invention;

FIG. 4 is a flowchart schematically showing an exemplary process of meeting creation, participant joining and media stream distribution according to one embodiment of the present invention;

FIG. 5 is a flowchart schematically showing another exemplary process of participant joining and media stream distribution according to one embodiment of the present invention; and

FIG. 6 is a flowchart schematically showing an exemplary process of ending meeting according to one embodiment of the present invention.

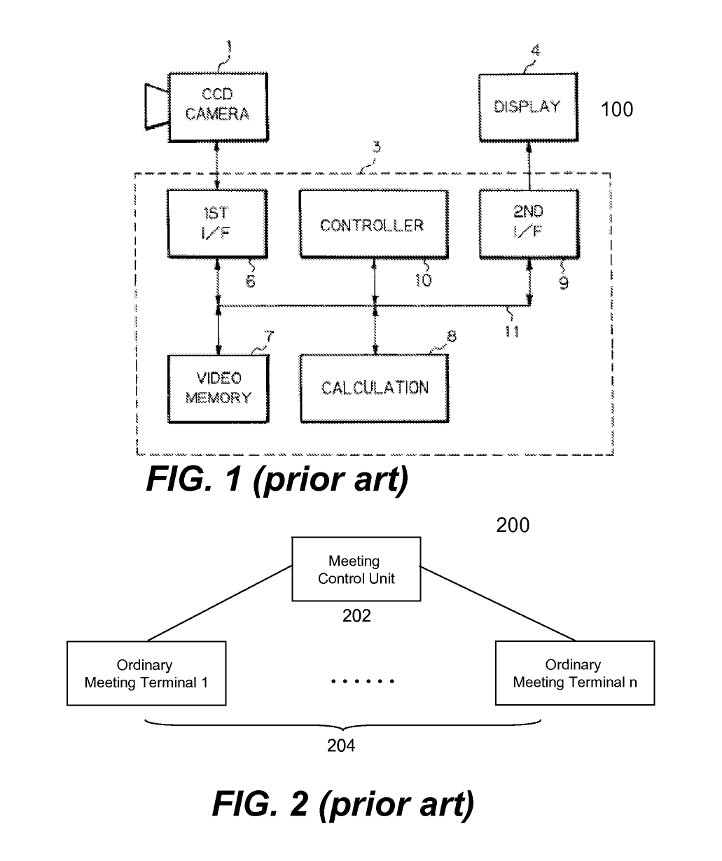

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

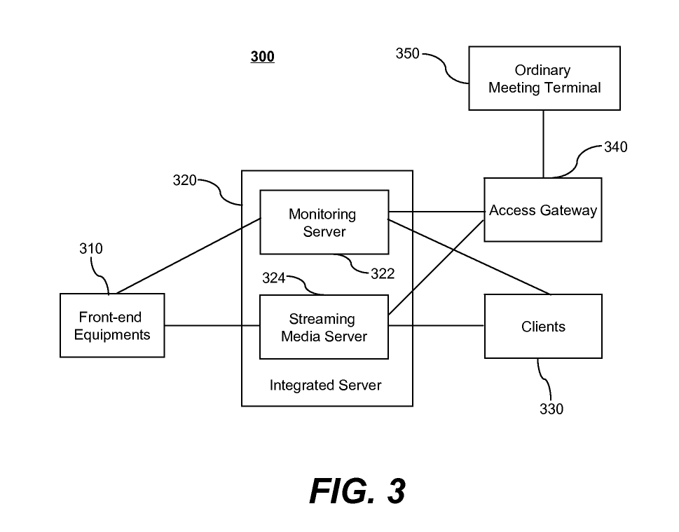

Embodiments of the present invention are discussed herein with reference to FIGS. 3-6. However, those skilled in the art will readily appreciate that the detailed description given herein with respect to these figures is for explanatory purposes only as the invention extends beyond these limited embodiments.

FIG. 3 is a block diagram schematically showing an integrated system for both surveillance and video conference or a video conference system based on a surveillance system. Such a system is also referred to as a video monitoring meeting system 300 according to one embodiment of the present invention. The system 300 comprises a plurality of front-end devices 310, an integrated (center platform) server 320 including a monitoring server 322 and a streaming media server 324, and a plurality of clients 330. In one embodiment, the system 300 further comprises an access gateway 340 and a plurality of meeting terminals 350 communicating with the center platform server 320 via the access gateway 340.

The monitoring server 322 is configured to manage various ongoing video meetings in addition to providing the monitoring function. The streaming media server 324 is responsible for storage and transmission of media streams for ongoing meetings in addition to storage and transmission of media streams in the monitoring process. The front-end devices 310 serve as meeting participants in addition to as information collection terminals for the monitoring process. The clients 330 are provided for conducting the meetings in addition to the monitoring process. The clients 330 may be divided into clients used as moderators (also referred as moderator clients or chairman clients) or clients used as participants (also referred as participant clients or member clients) depending on operations.

One of characteristics or advantages in the present invention is that the meeting terminals 350 can be connected to join a meeting in the system 300 via the access gate 340. The access gateway 340 is provided for protocol conversion between the meeting terminal 350 and the monitoring server 322 as well as between the meeting terminal 350 and the streaming media server 324 to facilitate seamless transmission of signal and media streams. According to one embodiment, signal standards or/and transmission protocols for surveillance and video conference are very different. To facilitate the media streams for surveillance or for video conference to go through the monitoring server 322 and the streaming media server 324, the access gateway 340 is provided to convert one signal standard to another to in accordance with a protocol.

Depending on implementation, the monitoring server 322 creates a meeting room in response to a request from one client used as a moderator. When the moderator client starts up a meeting, the monitoring server 322 gives a meeting start instruction to the streaming media server 324. According to the meeting start instruction from the monitoring server 322, the streaming media server 324 assigns an audio mixing point to the meeting, causes the clients 310 or/and the front-end devices 330 already listed as meeting participants to join the audio mixing point, where the monitoring server 322 is configured to mix audio streams from the meeting participants, and distributes the mixed audio streams to other meeting participants.

In one embodiment, after receiving the meeting start instruction from the monitoring server 322, the streaming media server 324 may cause the meeting terminals 350 already listed as the meeting participants to join the audio mixing point via the access gateway 340, and distribute the mixed audio streams to the other meeting terminals 350 via the access gateway 340.

The front-end devices 310, the clients 330, and the meeting terminals 350 are viewed as the meeting participants. Each of the front-end devices 310 further comprises one or more video monitoring cameras, internet protocol (IP) cameras, digital video servers (DVS), digital video recorders (DVR) and CODECS. Hence, the system 300 has various types of the meeting participants which have different receiving and transferring capability for video streams. For example, video monitoring cameras, IP cameras, DVS, and DVR all can transfer the video streams, and receive the video streams in conjunction with the clients 330. Further the clients 330 can receive the video streams, and also transfer the video streams in conjunction with the video capturing devices, such as IP camera, DVS and DVR; and the meeting terminals not only can receive the video streams, but also can transfer the video streams. Therefore, it needs to transfer the video streams selectively according to the capability of receiving participants in a video meeting.

Depending on implementation, one meeting participant may optionally select to watch a video from a particular participant. For example, if a client A wants to watch the video from a IP camera, the client A may request the monitoring server 322 to watch the video from the IP camera. Then, the monitoring server 322 instructs the streaming media server 324 to assign a video forwarding point and cause corresponding participants including the client A and the IP camera to join the video forwarding point. According to the instruction from the monitoring server 322, the streaming media server 324 assigns a video forwarding point, causes corresponding participants including the client A and the IP camera to join the video forwarding point, receives the video streams from the IP camera, and forwards the video streams to the client A.

In one embodiment, if one of the meeting terminal 350 wants to watch the video from a selected participant, the monitoring server 322 may instruct the streaming media server 324 to cause the particular meeting terminal to join the video forwarding point. According to the instruction of the monitoring server 322, the streaming media server 324 may also cause the meeting terminal to join the video forwarding point via the access gateway 340, receive the video streams from the selected participant, and forward the video streams to corresponding participants including the meeting terminal 350. If the meeting terminal 350 is regarded as the selected participant, the streaming media server 324 may receive the video streams from the meeting terminal 350 via the access gateway 340, and forward the video streams to corresponding participants.

There are several ways to cause the clients, the front-end devices, or/and the meeting terminals to join an audio mixing point and/or a video forwarding point. Two effective ways are listed as examples hereafter.

The first one is referred as joining by invitation. Specifically, a list of meeting participants provided by the moderator client is pre-stored into the monitoring server 322. Then, the monitoring server 322 sends a meeting invitation to each participant in the list, and cause the participants accepting the invitations to join the audio mixing point and/or the video forwarding point.

The second way is referred as joining by request. Specifically, the clients, the front-end devices, or/and the meeting terminals regarded as meeting participants send a request for joining a meeting to the monitoring server 322. Then, the monitoring server 322 determines whether the participants sending the request are permitted to join the meeting, and causes the permitted participant to join the audio mixing point and/or the video forwarding point if they are indeed permitted. The front-end devices (e.g. CODEC) may send a request for joining a meeting by level switch signal or other ways.

When the audio meeting needs to be ended, the moderator client may send a request for ending meeting to the monitoring server 322. The monitoring server 322 instructs other participants to stop the audio transmission, and instructs the streaming media server 324 to remove the participants from the audio mixing point and delete the audio mixing point finally. Correspondingly, the streaming media server 324 remove the participants from the audio mixing point and delete the audio mixing point finally according to the notice of the monitoring server 322.

The monitoring server 322 instructs the streaming media server 324 to remove corresponding meeting participants from the video forwarding point when the moderator client or other meeting participants request to end the video watching. The monitoring server 322 instructs the streaming media server 324 to delete the video forwarding point when all meeting participants are removed from the video forwarding point, and instructs the selected meeting participants to stop the video transmission. Correspondingly, the streaming media server 324 removes corresponding meeting participants from the video forwarding point, and deletes the video forwarding point finally according to the notice of the monitoring server 322.

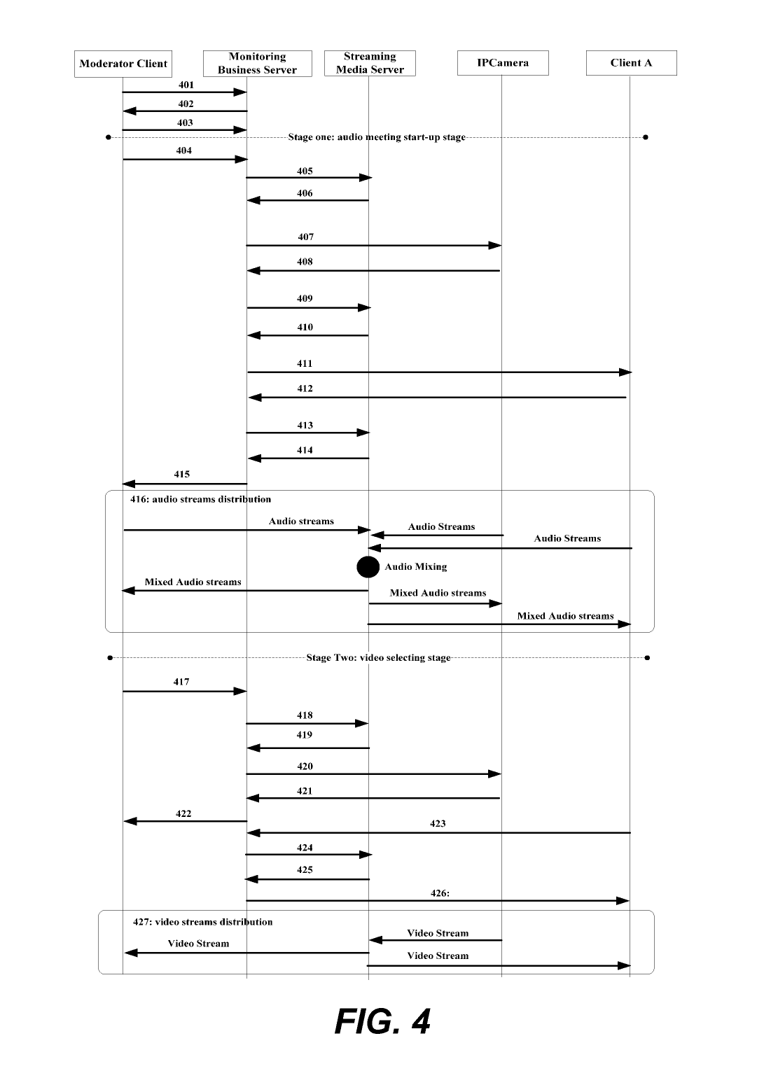

FIG. 4 is a flowchart schematically showing an exemplary process of creating a meeting, joining a participant and distributing a media stream according to one embodiment of the present invention. The minimum requirement for a meeting is that there are a moderator client, a client A, and a front-end device (e.g., an IP camera). The process comprises following operations.

At 401, the moderator client sends a request for creating meeting to the monitoring server.

At 402, the monitoring server creates a meeting room, generates a meeting number corresponding to the meeting room, and returns the meeting number to the moderator client. As a result, the meeting room is created for the moderator client successfully.

At 403, the moderator client sets a list of meeting participants for the meeting room. In one embodiment, the list of meeting participants comprises the client A and the IP camera.

Next, an audio meeting start-up stage is described in details.

At 404, the moderator client sends a request for starting up meeting to the monitoring server, and informs the monitoring server of capability information thereof. The media capability of the moderator client comprises a codec format and an IP address of the moderator client.

At 405, the monitoring server instructs the streaming media server to create an audio mixing point, informs the streaming media server of the media capability information of the moderator client, and instructs the streaming media server to cause the moderator client to join the audio mixing point.

At 406, the streaming media server creates the audio mixing point, causes the moderator client to join the audio mixing point, responds a message indicating that the audio mixing point is created successfully to the monitoring server, and returns media capability of the audio mixing point to the monitoring server. The media capability of the audio mixing point comprises a media format available for the audio mixing point and a receiving address of the audio mixing point.

At 407, the monitoring server invites the IP camera to join the audio meeting, informs the IP camera of the media capability of the audio mixing point, and instructs the IP camera to send audio streams to the audio mixing point.

At 408, the IP camera responds a successful startup message to the monitoring server, and informs the monitoring server of media capability thereof. Likewise, the media capability of the IP camera comprises a codec format and an IP address of the IP camera.

At 409, the monitoring server informs the streaming media server of the media capability of the IP camera, and instructs the streaming media server to cause the IP camera to join the audio mixing point.

At 410, the streaming media server causes the IP camera to join the audio mixing point, and responds a message indicating that the IP camera is joined into the audio mixing point successfully to the monitoring server.

At 411, the monitoring server invites the client A to join the audio meeting, informs the client A of the media capability of the audio mixing point, and instructs the client A to send audio streams to the audio mixing point.

At 412, the client A responds a successful startup message to the monitoring server, and informs the monitoring server of media capability thereof. Likewise, the media capability of the client A comprises a codec format and an IP address of the client A.

At 413, the monitoring server informs the streaming media server of the media capability of the client A, and instructs the streaming media server to cause the client A to join the audio mixing point.

At 414, the streaming media server causes the client A to join the audio mixing point, and responds a message indicating that the client A is joined into the audio mixing point successfully to the monitoring server.

At 415, the monitoring server responds a message indicating that the audio meeting is started up successfully to the moderator client, and informs the moderator client of the media capability of the audio mixing point so that the moderator client may send the video streams according to the media capability of the audio mixing point.

At 416, the audio streams are mixed and distributed. Each meeting participant including the moderator client, the client A or the IP camera sends audio streams to the streaming media server. The streaming media server mixes the audio streams from the meeting participants at the audio mixing point, and distributes the mixed audio streams to corresponding meeting participant according to the media capability of each meeting participant.

Next, a video selecting stage is described in details.

At 417, the moderator client requests the monitoring server to watch video from the IP camera.

At 418, the monitoring server instructs the streaming media server to create a video forwarding point, informs the streaming media server of the media capability information of the moderator client, and instructs the streaming media server to cause the moderator client to join the video forwarding point.

At 419, the streaming media server creates the video forwarding point, causes the moderator client to join the video forwarding point, responds a message indicating that the video forwarding point is created successfully to the monitoring server, and returns media capability of the video forwarding point to the monitoring server. The media capability of the video forwarding point comprises a media format available for the video forwarding point and a receiving address of the video forwarding point.

At 420, the monitoring server starts up the video of the IP camera, informs the IP camera of the media capability of the video forwarding point, and instructs the IP camera to send the video streams to the video forwarding point.

At 421, the IP camera responds a message indicating that the video of the IP camera is started up successfully to the monitoring server.

At 422, the monitoring server informs the moderator client that the video of the IP camera is started up successfully.

At 423, the client A requests the monitoring server to watch the video from the IP camera.

At 424, the monitoring server instructs the streaming media server to cause the client A to join the video forwarding point.

At 425, the streaming media server causes the client A to join the video forwarding point, and responds a message indicating that the client A is joined into the video forwarding point successfully to the monitoring server.

At 426, the monitoring server responds to the client A that the video from the IP camera is watched successfully.

At 427, the video streams are distributed. The IP camera sends the video streams to the streaming media server. The streaming media server forwards the video from the IP camera to the moderator client and the client A via the video forwarding point.

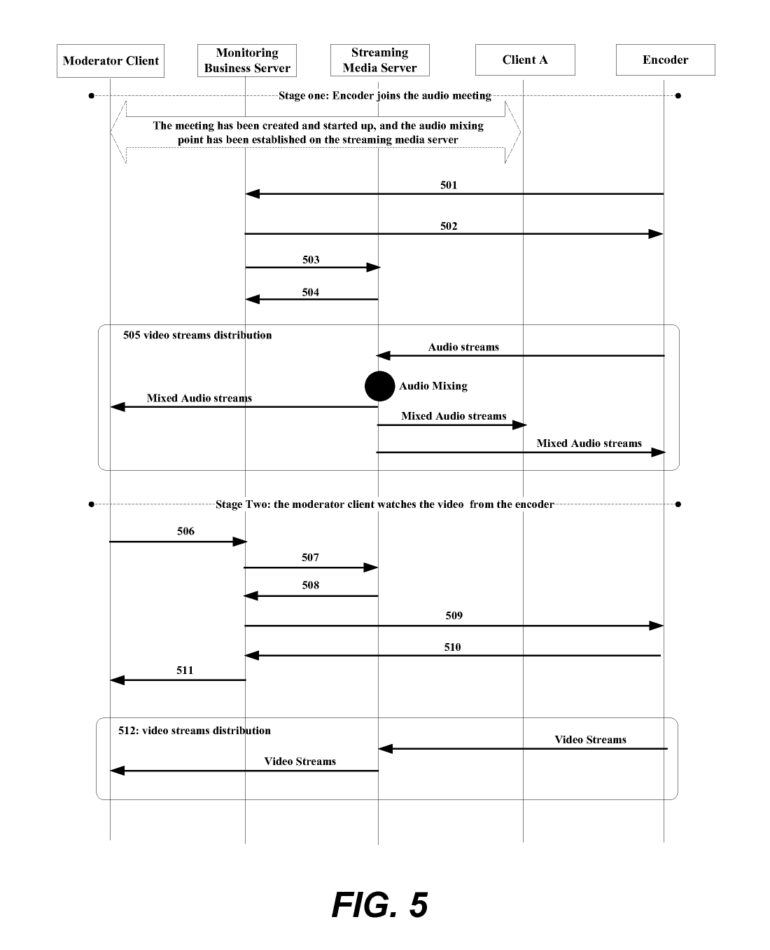

In the above operations, the meeting participants join the meeting by the invitation. Next, another situation that the meeting participants join the meeting by the request will be described in detail. FIG. 5 is a flow chart schematically showing another exemplary process of participant joining and media stream distribution according to one embodiment of the present invention. Referring to FIG. 5, the clients comprise a moderator client and a client A, and the front-end equipment is an encoder. In this embodiment, it is assumed that the meeting has been created and stared up, the audio mixing point has been established on the streaming media server, and the moderator client and the client A have joined the audio mixing point. The process further comprises the following operations.

A stage of the encoder joining the audio meeting is described firstly. At 501, the encoder requests the monitoring server to join the audio meeting by a level switch signal. As the same time, media capability of the encoder is reported to the monitoring server. The media capability comprises a codec format and an IP address of the encoder.

At 502, the monitoring server determines whether the encoder has permissions to join the meeting, responds a message indicating that the encoder joins the meeting successfully when the encoder has permissions to join the meeting, and instructs the encoder to send the audio streams to the audio mixing point.

At 503, the monitoring server instructs the streaming media server to cause the encoder to join the audio mixing point. At 504, the streaming media server causes the encoder to join the audio mixing point, and responds a message indicating that the encoder joins the audio mixing point successfully to the monitoring server.

At 505, the audio streams is mixed and distributed. The meeting participants including the encoder send the audio streams to the streaming media server, respectively. The streaming media server mixes the audio streams from the meeting participants at the audio mixing point, and distributes the mixed audio streams to corresponding meeting participant according to the media capability of each meeting participant.

Next, the moderator client requests to watch the video from the encoder. At 506, the moderator client requests the monitoring to watch the video from the encoder. At 507, the monitoring server instructs the streaming media server to create a video forwarding point, informs the streaming media server of the media capability information of the moderator client, and instructs the streaming media server to cause the moderator client to join the video forwarding point.

At 508, the streaming media server creates the video forwarding point, causes the moderator client to join the video forwarding point, responds a message indicating that the video forwarding point is created successfully to the monitoring server, and returns media capability of the video forwarding point to the monitoring server. The media capability of the video forwarding point comprises a media format available for the video forwarding point and a receiving address of the video forwarding point.

At 509, the monitoring server starts up the video of the encoder, informs the encoder of the media capability of the video forwarding point, and instructs the encoder to send the video streams to the video forwarding point. At 510, the encoder responds a message indicating that the video of the encoder is started up successfully to the monitoring server.

At 511, the monitoring server informs the moderator client that the video of the encoder is started up successfully. At 512, the video streams are distributed. The encoder sends the video streams to the streaming media server. The streaming media server forwards the video from the encoder to the moderator client via the video mixing point.

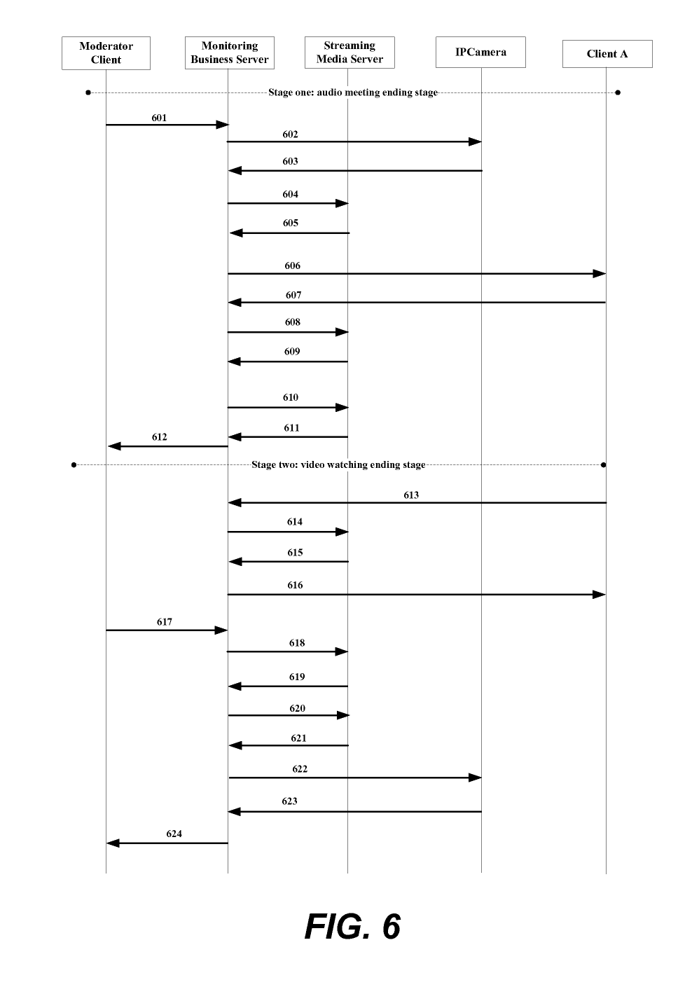

FIG. 6 is a schematic flow chart showing one exemplary process of ending meeting according to one embodiment of the present invention. Referring to FIG. 6, the process comprises the following operations.

The audio meeting ending stage is described hereafter. At 601, the moderator client requests the monitoring server to end the current audio meeting. At 602, the monitoring server instructs the IP camera to stop audio transmission and exit from the audio mixing point. At 603, the IP camera stops the audio transmission, and responds a message indicating that the audio is ended successfully to the monitoring server.

At 604, the monitoring server instructs the streaming media server to remove the IP camera from the audio mixing point. At 605, the streaming media server removes the IP camera from the audio mixing point, and responds a message indicating that the IP camera is removed form the audio mixing point successful to the monitoring server.

At 606, the monitoring server instructs the client A to stop audio transmission and exit from the audio mixing point. At 607, the client A stops the audio transmission, and responds a message indicating that the audio is ended successfully to the monitoring server. At 608, the monitoring server instructs the streaming media server to remove the client A from the audio mixing point.

At 609, the streaming media server removes the client A from the audio mixing point, and responds a message indicating that the client A is removed form the audio mixing point successfully to the monitoring server. At 610, the monitoring server instructs the streaming media server to remove the moderator client from the audio mixing point and delete the audio mixing point.

At 611, the streaming media server removes the moderator client from the audio mixing point, deletes the audio mixing point, and responds a message indicating that the audio mixing point is deleted successfully to the monitoring server. At 612, the monitoring server informs the moderator client that the audio meeting is ended successfully.

The video watching ending stage is described hereafter. At 613, the client A requests to stop watching the video from the IP camera. At 614, the monitoring server instructs the streaming media server to remove the client A from the video forwarding point. At 615, the streaming media server removes the client A from the video forwarding point, and responds a message indicating that the client A is removed form the video forwarding point successfully to the monitoring server.

At 616, the monitoring server informs the client A that the video watching is ended successfully. At 617, the moderator client requests to stop watching the video from the IP camera. At 618, the monitoring server instructs the streaming media server to remove the moderator client from the video forwarding point.

At 619, the streaming media server removes the moderator client from the video forwarding point, and responds a message indicating that the moderator client is removed form the video forwarding point successfully to the monitoring server. At 620, the monitoring server instructs the streaming media server to delete the video forwarding point. At 621, the streaming media server deletes the video forwarding point, and responds a message indicating that the video forwarding point is deleted successfully to the monitoring server.

At 622, the monitoring server instructs the IP camera to stop video transmission. At 623, the IP camera responds a message indicating that the video transmission of the IP camera is stopped. At 624, the monitoring server informs the moderator client that the video watching is ended successfully.

It can be seen that the signaling control and the media stream control in the meeting system 300 separated from each other are implemented on the monitoring server and the streaming media server, respectively. As a result, the meeting can be achieved based on the video monitoring system.

Furthermore, the meeting terminals may join the meeting by different ways so that the system 300 can support more meeting terminals. Additionally, the system 300 further comprises the meeting terminals of the conventional meeting system in addition to the various terminal devices of the video monitoring system.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A video conference system based on a surveillance system, the video conference system comprising:
a plurality of clients each being used as a meeting moderator or an meeting participant;
a plurality of front-end devices each used as a meeting moderator or an meeting participant;
a monitoring server configured for creating a meeting room according to a request from the meeting moderator and sending an instruction when the meeting moderator starts up the meeting; and
a streaming media server configured for assigning an audio mixing point, causing the meeting participants to join the audio mixing point, receiving and mixing audio streams from the meeting participants joined to the audio mixing point, and distributing the mixed audio streams to corresponding meeting participants according to the instruction from the monitoring server.

2. The video conference system according to claim 1, further comprising:
a plurality of meeting terminals; and
an access gateway provided for protocol conversion between the meeting terminals and the monitoring server, as well as between the meeting terminal and the streaming media server, wherein
the monitoring server instructs the streaming media server to cause one or more meeting terminals used as the meeting participants to join the audio mixing point via the access gateway,
the streaming media server causes the meeting terminals used as the meeting participants to join the audio mixing point, receives audio streams from the meeting terminals via the access gateway, mixes the audio streams from the meeting participants including the meeting terminals, and distributes the mixed audio streams to corresponding meeting participants.

3. The video conference system according to claim 1, wherein
the monitoring server instructs the streaming media server to remove the meeting participants from the audio mixing point and delete the audio mixing point in response to a request of the meeting moderator, and
the streaming media server removes the meeting participants from the audio mixing point and deletes the audio mixing point according to the instruction of the monitoring server.

4. The video conference system according to claim 1, wherein
when one meeting participant requests to watch video from another selected meeting participant, the monitoring server instructs the streaming media server to assign a video forwarding point and cause corresponding meeting participants to join the video forwarding point, and
the streaming media server assigns the video forwarding point, and causes corresponding meeting participants to join the video forwarding point, receives video streams from the selected meeting participant, and forwards the video streams to corresponding meeting participants according to the instruction of the monitoring server.

5. The video conference system according to claim 4, further comprising:
a plurality of meeting terminals; and
an access gateway provided for protocol conversion between the meeting terminals and the monitoring server, and between the meeting terminal and the streaming media server; and wherein
the monitoring server instructs the streaming media server to cause the meeting terminals used as the meeting participants to join the audio mixing point or the video forwarding point via the access gateway;
the streaming media server receives audio streams from the meeting terminals via the access gateway, mixes the audio streams from the meeting participants including the meeting terminals, and distributes the mixed audio streams to corresponding meeting participants;
when one meeting terminal requests to watch video from another selected meeting participant, the streaming media server further receives video streams from the selected meeting participant, and forwards the video streams to corresponding meeting participants including the meeting terminal;
when one meeting terminal is selected as the selected meeting participant, the streaming media server further receives video streams from the meeting terminal, and forwards the video streams to corresponding meeting participants.

6. The video conference system according to claim 4, wherein
the monitoring server instructs the streaming media server to remove corresponding meeting participants from the video forwarding point and delete the video forwarding point finally, and instructs the selected meeting participant to stop vide transmission according to a request of the meeting moderator or other meeting participants;
the streaming media server removes corresponding meeting participants from the video forwarding point and deletes the video forwarding point finally according to the instruction of the monitoring server.

7. A video conference method based on a surveillance system a monitoring server and a streaming media server, the method comprising:
creating a meeting room according to a request of a meeting moderator by the monitoring server;
sending an instruction by the monitoring server when the meeting moderator starts up the meeting;
assigning an audio mixing point and causing meeting participants to join the audio mixing point according to the instruction of the monitoring server by the streaming media server; and
receiving and mixing audio streams from the meeting participants joined to the audio mixing point and distributing the mixed audio streams to corresponding meeting participants by the streaming media server.

8. The method according to claim 7, further comprising:
instructing the streaming media server to cause an meeting terminal used as the meeting participant to join the audio mixing point by the monitoring server.

9. The method according to claim 7, further comprising:
instructing the streaming media server to assign a video forwarding point and cause corresponding meeting participants to join the video forwarding point by the monitoring server when one meeting participant requests to watch video from a selected meeting participant; and
receiving video streams from the selected meeting participant and forwarding the video streams to corresponding meeting participant.

10. The method according to claim 7, further comprising:
instructing the streaming media server to remove the meeting participants from the audio mixing point and delete the audio mixing point finally by the monitoring server when the meeting moderator requests to end the meeting.

11. The method according to claim 9, further comprising:
instructing the streaming media server to remove corresponding meeting participants from the video forwarding point and delete the video forwarding point finally, and instructs the selected meeting participant to stop vide transmission according to a request of the meeting moderator or other meeting participants.

12. The method according to claim 7, further comprising:
storing a list of meeting participants in the monitoring server by the meeting moderator; and wherein
the causing meeting participants to join the audio mixing point comprises:
inviting corresponding meeting participants to join the meeting according to the list of meeting participants; and
causing the meeting participants accepting the invitations to join the audio mixing point.

13. The method according to claim 12, wherein the meeting participants comprise one or more clients, one or more front-end devices and one or more meeting terminals.

14. The method according to claim 13, further comprising:
inviting the meeting participants to join the meeting according to the list of meeting participants via an access gateway; and
causing the meeting participants accepting the invitations to join the audio mixing point.

15. The method according to claim 7, wherein the causing meeting participants to join the audio mixing point comprises:
requesting the monitoring server to join the meeting by the meeting participants;
determining whether the meeting participants have permissions to join the meeting by the monitoring server; and
cause the meeting participants having permissions to join the audio mixing point.
